(19) United States
(12) Patent Application Publication
(10) Pub. No.: US 2014/0101397 A1
(43) Pub. Date: Apr. 10, 2014

(54) REMOTE REDUNDANT ARRAY OF INEXPENSIVE MEMORY

(71) Applicant: SAP AG, Walldorf (DE)

(72) Inventors: Aidan Shribman, Tel Aviv (IL); Peter Izsak, Tel Aviv (IL); Benoit Hudzia, Belfast (GB); Roei Tell, Tel Aviv (IL)

(73) Assignee: SAP AG, Walldorf (DE)

(21) Appl. No.: 13/646,433

(22) Filed: Oct. 5, 2012

(51) Int. Cl. G06F 12/16

(52) U.S. Cl. 711/162; 711/E12.103

(57) ABSTRACT

A method for retrieving stored information from a storage node includes operating a computing device to generate a memory access request comprising a virtual memory address that identifies a first storage node and at least a second storage node based on the virtual memory address. The method further includes operating the computing device to transmit a retrieve request to both the first storage node and the second storage node to retrieve stored information. The first and the second storage nodes are each enabled to store a copy of the stored information, and are included in a plurality of storage nodes that constitute an extended memory. If a first response from the first storage node is received before a second response is received from the second storage node, then the method further includes operating the computing devices to receive the stored information from the first storage node.

### BACKGROUND

The present disclosure relates to a remote redundant array of inexpensive memory, and in particular, to a fault tolerant method for storing information in the remote redundant array of inexpensive memory.

Unless otherwise indicated herein, the approaches described in this section are not prior art to the claims in this application and are not admitted to be prior art by inclusion in this section.

Many business and research applications use large amounts of online data that is frequency accessed from “main” memory during execution. Main memory is distinguished from disk-based storage devices such as magnetic disk or optical disk storage devices. Main memory is most commonly provided with dynamic random access memory (DRAM), although other read/writable technologies may be used. As used herein, main memory may be referred to as simply “memory”.

The amount of online data that can be used by the applications can be constrained by the lack of available memory. There are generally two alternatives to increase the amount of memory. Memory can either be scaled-out by increasing the number of physical machines that provide memory, or scaled-up by replacing existing physical machines with more costly physical machines that have larger and/or faster memories. If the constraint on available memory is not corrected, then there is a high possibility that the performance of the applications will be degraded due to reliance on disk drive backed storage, which is slower than main memory.

Scaling-out the physical machines to include multiple physical machines would potentially allow the applications to run on a grid of computing devices, but may require significant modification to the applications comprising the software stack. In the alternative, scaling-up is generally limited by the physical constraints of a single node, and is expensive as it may require the purchase of costly high-end servers.

One alternative to the traditional scale-up and scale-out solutions includes the use of commodity memory nodes, which provide remote memory to computing devices that run the application. The use of remote memory from remote commodity memory nodes provides an alternative to scale-up and scale-out solutions. Remote commodity memory nodes do not, however, provide fault tolerance, and are, therefore, susceptible to a loss of data in case of failure.

### BRIEF DESCRIPTION OF THE DRAWINGS

FIG. 1 illustrates a computing system in accordance with the present disclosure.

FIG. 2 depicts mapping between a virtual address space and a physical address space.

FIG. 3 depicts a high-level flow diagram illustrating a process for retrieving information that may be stored in two different storage nodes in accordance with the present disclosure.

FIG. 4 depicts a high-level flow diagram where the second storage node does not transmit a response to the memory access request according to one embodiment.

FIG. 5 depicts a high-level flow diagram where the second storage node does not transmit a response to the memory access request according to an alternative embodiment.

FIG. 6 depicts the virtual mapping subsystem of the computing device.

### DETAILED DESCRIPTION

Described herein are techniques for improving fault tolerance using a remote redundant array of inexpensive memory. In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

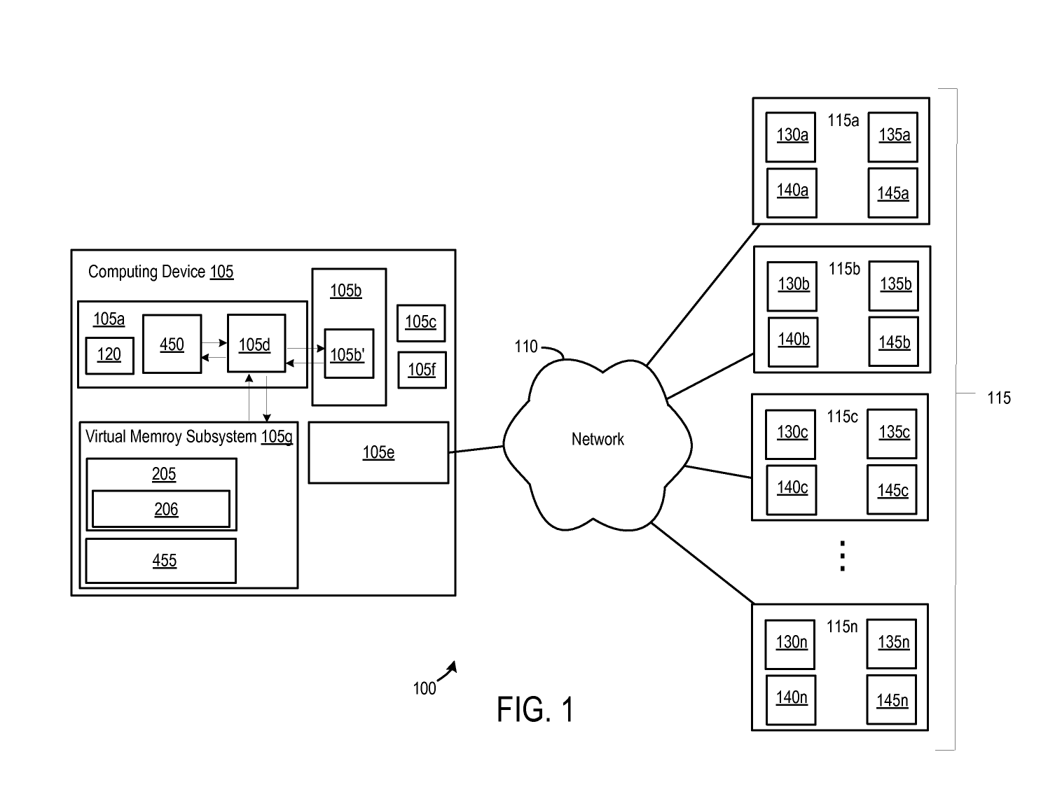

FIG. 1 illustrates a computing system 100 according to one embodiment. Computing system 100 includes a computing device 105, a network 110, and a number of storage nodes 115 that are respectively identified by reference numbers 115a, 115b, 115c . . . 115n. Computing device 105 includes a processor 105a, an operating system 105b, which includes a kernel 105b′, a first memory 105c, and a memory management unit (MMU) 105d. Computing device 105 also includes a network communication controller 105e, a second memory 105f (e.g., a local hard disk drive), and a virtual mapping subsystem 105g. First memory 105c may be main memory, which is most commonly provided with dynamic random access memory (DRAM), although other read/writable technologies may be used. Second memory 105f may be a non-transitory computer readable storage medium that stores an application 120. Application 120 includes computer code that may be transferred from second memory 105f to processor 105a for execution. First memory 105c may be accessed by application 120 during execution for storing and retrieving application data. The application data may be used and/or generated by application 120 during execution. MMU 105d and virtual mapping subsystem 105g are described below.

According to one embodiment, network 110 may be comprised of a variety of communication networks such as one or more intranets, the Internet, etc. The network communication node 105e of computing device 105 may control communications with network 110 and storage nodes 115. Network links included in network 110 may be relatively high speed network links, such as 10 gigabit Ethernet links, Infiniband links, etc.

Turning to storage nodes 115, the storage nodes may constitute a remote redundant array of inexpensive memory. Each storage node 115 may include a server computer that includes main memory. Specifically, storage nodes 115 may respectively include processors (labeled 130a, 130b, 130c . . . 130n), first memories (labeled 135a, 135b, 135c . . . 135n), second memories (e.g., local disk drives labeled 140a, 140b, 140c . . . 140n), and network communication controllers 145a, 145b, 145c . . . 145n. First memories 135a, 135b, 135c . . . 135n may constitute main memory and may be DRAMs or the like. Second memories 140a, 140b, 140c . . . 140n may be non-transitory computer readable storage mediums that store computer code for various applications that operate on storage nodes 115. Network communication controllers 145a, 145b, 145c . . . 145n may control communication with network 110 and computing device 105.

As described briefly above, application 120 may execute on computing device 105 and may use and/or generate information during execution. Information used and/or generated by application 120 is stored locally in the first memory 105c, and/or may be stored remotely in two or more of the storage nodes 115. According to one embodiment MMU 105d, which may be included in processor 105a, controls the storage and retrieval of information to and from first memory 105c and storage nodes 115 for application 120. For example, MMU 105d may control the transfer of information from first memory 105c in computing device 105 to the storage nodes 115 when the first memory 105c becomes full.

MMU 105d is presently described in further detail. According to one embodiment, MMU 105d accesses a translation lookaside buffer 405 and/or the virtual memory subsystem 105g in order to further access a virtual address space of virtual addresses. The virtual addresses of the virtual address space map to the physical addresses of a physical address space (e.g., first memories 135 of storage nodes 115). MMU 105d performs the mapping between the virtual addresses and the physical addresses.

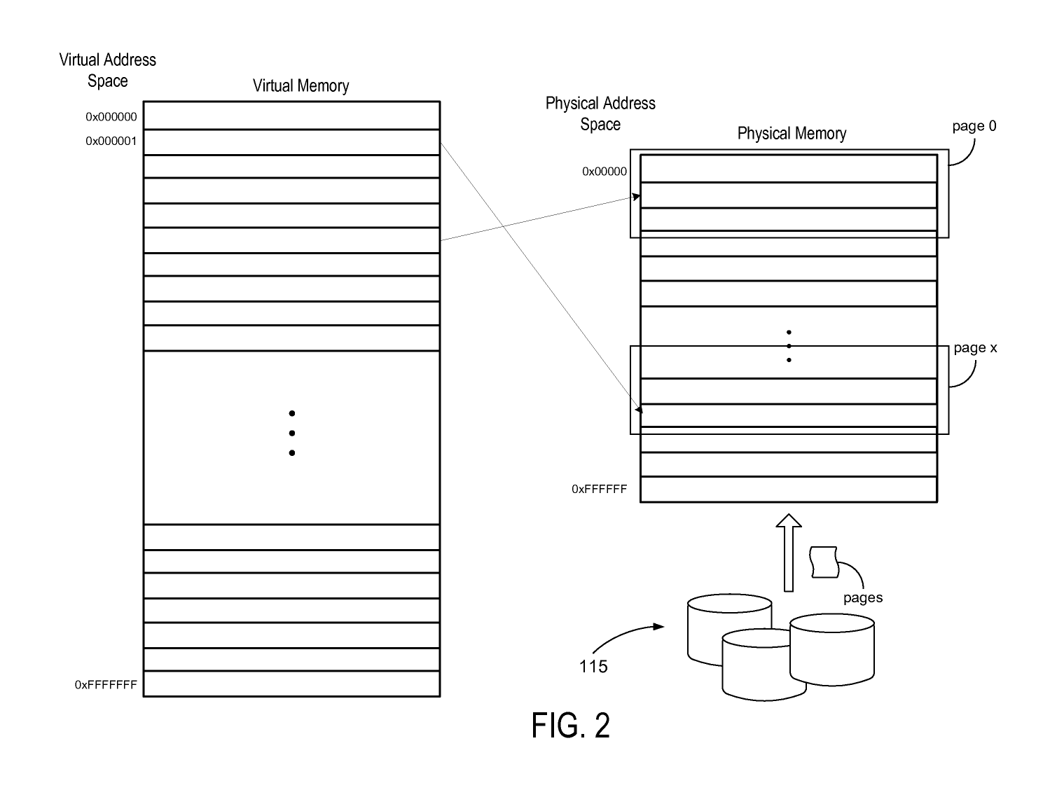

FIG. 2 depicts an example mapping between virtual addresses in the virtual address space of virtual memory and physical addresses in the physical address space of physical memory (e.g., 105c) in accordance with the present disclosure. The virtual address space is shown on the left side of FIG. 2 and the physical address space is shown on the right side of FIG. 2.

The virtual address space is partitioned into pages that may be stored among storage nodes 115. In accordance with the present disclosure, a page of virtual memory may be mirrored over two or more storage nodes 115. Pages of virtual memory may be loaded from storage nodes 115 into different locations in physical memory as needed. The MMU 105d manages mapping tables to keep track of which pages of virtual memory are loaded in physical memory and which pages are stored in the storage nodes 115. According to one embodiment, when application 120 accesses the virtual memory to retrieve the data, MMU 105d responds in part by mapping the virtual address for the data to its corresponding page and determining if the corresponding page is stored in physical memory. If the corresponding page is not resident in physical memory, then the page is retrieved from storage nodes 115. If the corresponding page is resident in physical memory, then the data requested by application 120 is simply retrieved from physical memory for use.

According to a specific embodiment, each virtual address is associated with at least two storage nodes 115 (e.g., 115a, 115b). The two storage nodes 115a, 115b may each store a mirrored copy of a page of virtual memory that contains the data being accessed. Further, MMU 105d may use the virtual address to control memory operations in the two storage nodes 115a, 115b. For example, MMU 105d may use the virtual address to mirror the virtual memory pages that contain the data in the two storage nodes 115a, 115b. MMU 105d may also use the virtual address to retrieve the data from the two storage nodes 115a, 115b. A method for retrieving the data from the two storage nodes 115a, 115b is presently described. While the following description describes the retrieval of the data from the two storage nodes 115a, 115b, the method may be applied to more than two storage nodes that store copies of the information.

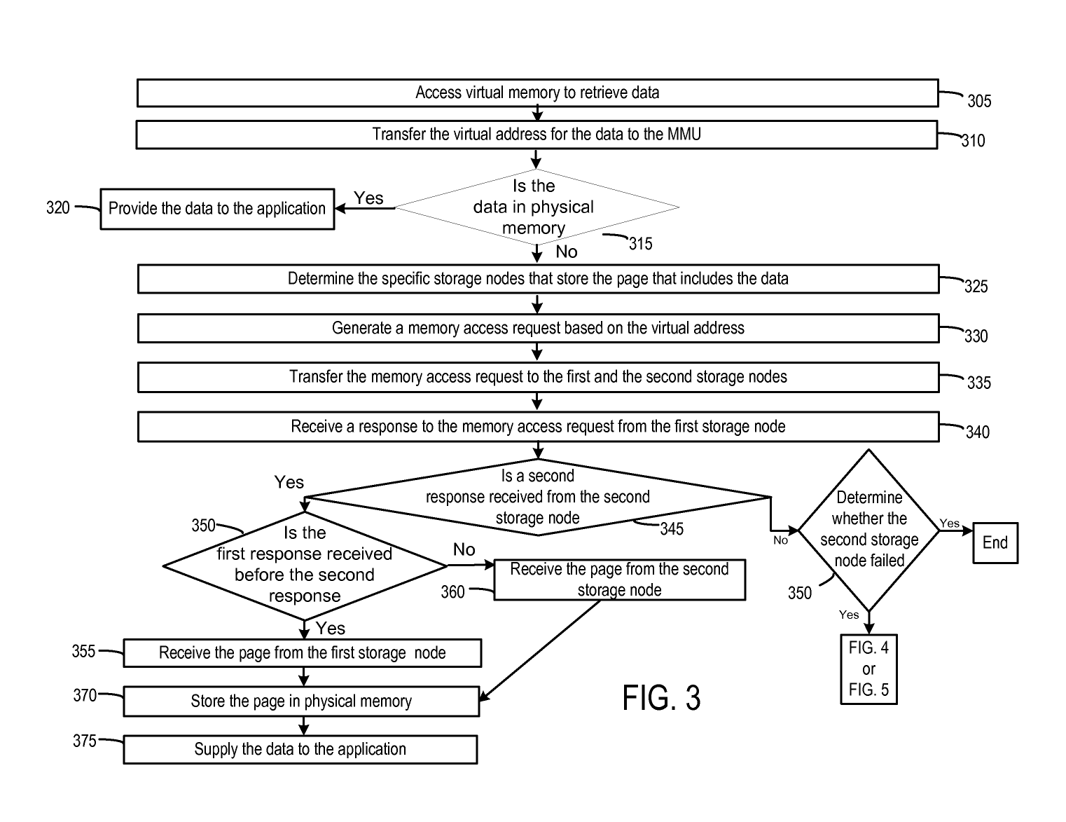

Referring to FIG. 3, this figure depicts a high-level flow diagram for a method for retrieving data from the two storage nodes 115 that store copies of the data according to one embodiment. The two storage nodes 115 are referred to as the first and the second storage nodes (e.g., storage nodes 115a and 115b). While the following describes the retrieval of data from two storage nodes that store copies of the data, the method may be applied to a greater number of storage nodes that store copies of the data. The high-level flow diagram represents an example embodiment and those of skill in the art will understand that various steps of the high-level flow diagram may be combined and/or added without deviating from the scope and the purview of the embodiment.

At 305, application 120 accesses data in a virtual memory space. At 310, the virtual address of the memory location associated with the data is transferred to MMU 105d. At 315, the MMU 105d determines whether the data is in physical memory. An embodiment for determining whether the data is in physical memory is described below. If MMU 105 determines that the data is in physical memory, the data is supplied to application 120 for use, step 320. Alternatively, if MMU 105 determines that the data is not in physical memory, then MMU 105 attempts to pull a page from the storage nodes 115 that contain the data.

At 325, MMU 105d determines the specific storage nodes 115 that store the page that includes the data. Computing device 105 may provide an auxiliary lookup table 455 (see FIG. 1.) that includes entries that identify the associations between the virtual address and the storage nodes 115 that store the page. MMU 105d may use the virtual address to access the entries from auxiliary lookup table 455 to determine the particular storage nodes 115 that are associated with the virtual address. For example, MMU 105d may use the virtual address to access the entries in auxiliary lookup table 455, and determine that the data is stored in a page in the first and the second storage nodes. Auxiliary lookup table 455 is described in further detail below.

At 330, computing device 105 generates a memory access request based on the determination by MMU 105 that the page is in the first and the second storage nodes. Thereafter, computing device 105 transmits the memory access request to both the first storage node and the second storage node to retrieve the page (step 335).

At 340, computing device 105 receives a first response to the memory access request from the first storage node. At 345, computing device 105 determines whether a second response to the memory access request is also received from the second storage node. If first and second responses are received, then computing device 105 determines, at 350, whether the first response is received before the second response. If the first response is received before the second response, then MMU 105d receives the page from the first storage node at 355 and ignores the second response. If the first response is not received before the second response, then MMU 105d receives the page from the second storage node at 360 and ignores the first response. At 370, the page is stored in physical memory. At 375, the data is supplied to application 120.

Regardless of whether computing device 105 receives the first response before the second response or after the second response, the data is supplied to application 120 relatively quickly because the data is supplied to application based on the response (either the first or the second) that is received first. That is, application 120 experiences no delay in receiving the data based on whether the first response is received before or after the second response.

At 345, if computing device 105 determines that a second response is not received from the second storage node, then a determination may be made whether the second storage node has failed, step 350. For example, one or more of the network communication controllers 105e and 145a . . . n may determine whether the second storage node failed. Alternatively, various systems of network 110 may determine whether the second storage failed. According to another alternative, one or more of the operating systems of the storage nodes 115 (e.g., other than the second storage node) may determine whether the second storage node failed. If the second storage node is determined to have failed, then the second storage node may be replaced with another storage node, removed from the set of storage node 115, or revived. Further, failure information that indicates that the second storage node failed may be transmitted to computing device 105. If the second node is determined not to have failed, then communication with the second storage node may proceed as described at steps 305 to 345.

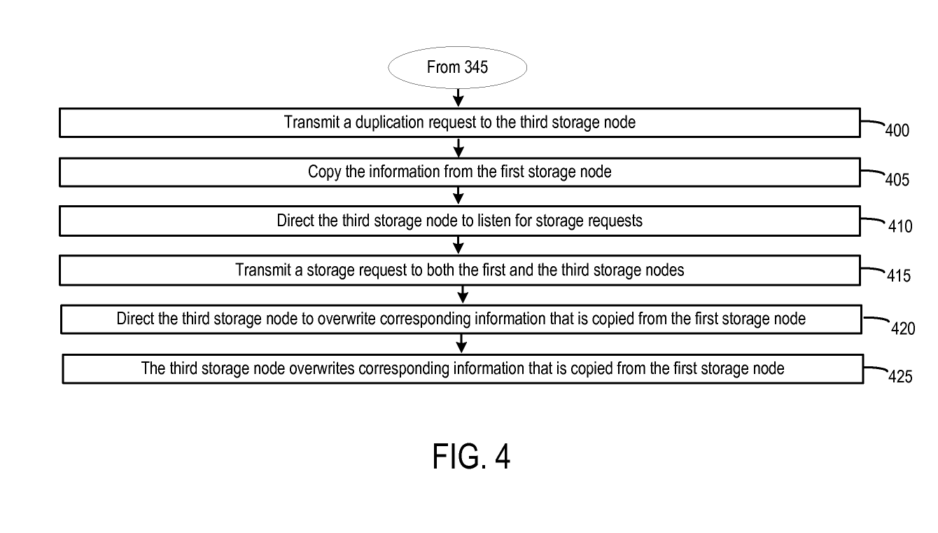

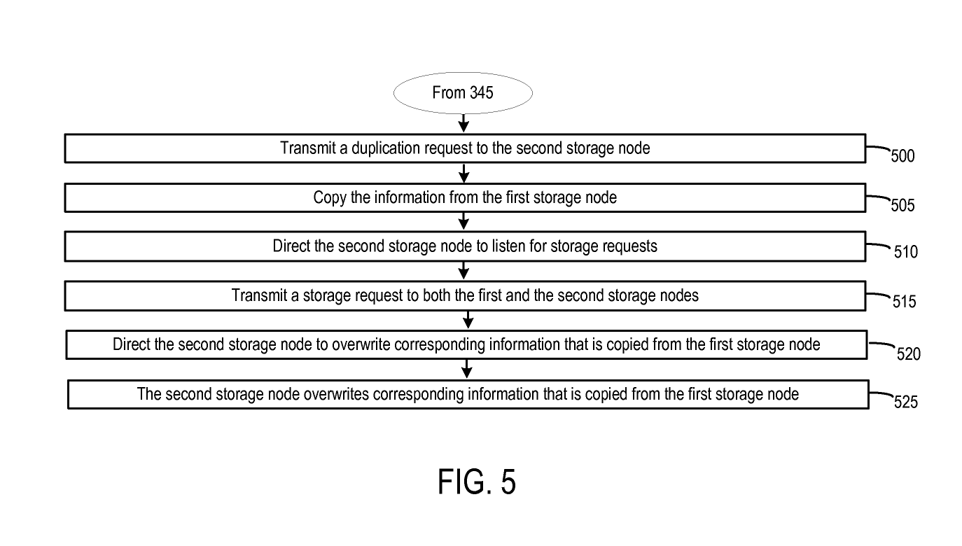

Reference is now made to FIGS. 4 and 5, these figures each depict high-level flow diagrams for embodiments where the second storage node does not transmit a response (e.g., determined at step 345) to the memory access request that is issued at 335 and the second storage node is verified as having failed at 350. FIG. 4 is described first below and FIG. 5 is described thereafter. The high-level flow diagrams in FIGS. 4 and 5 represent example embodiments and those of skill in the art will understand that various steps of the high-level flow diagram may be combined and/or added without deviating from the scope and the purview of the embodiment.

According to the embodiment depicted in FIG. 4, if at 345, computing device 105 determines that a second response is not received from the second storage node, and the second storage node is determined to have failed, then computing device 105 may attempt to replace the second storage node with a third storage node from computing system 100. To replace the second storage node with the third storage node, computing device 105 may transmit a duplication request to the first storage node to transmit information stored in the first storage node to the second storage node, step 400. Based on the duplication request, the first storage node may transmit the information to the third storage node, step 405.

According to alternative embodiment, at steps 400 and 405, computing device 105 may transmit a duplication request to the third storage node to copy (i.e., retrieve and store) information stored in the first storage node so that the first and third storages nodes will each store a copy of the information, step 400. Based on the duplication request, the third storage node may communicate with the first storage node to copy the information stored in the first storage node, step 405.

At 410, computing device 105 transmits a listen request to the third storage node that directs the third storage node to listen for storage requests issued by computing device 105, step 410. The duplication request transmitted to the third storage node may include the listen request.

A storage request may be transmitted to both the first storage node and the third storage node to direct the first and the third storage nodes to store information that is associated with the storage request, step 415. Further, the third storage node may be directed to overwrite any corresponding information that is copied from the first storage node, step 420, with information associated with the storage request.

At step, 425, the third storage node overwrites corresponding information that is copied from the first storage node. Alternatively, at steps 420 and 425, if the information associated with the storage request is stored in the third storage node before the information from the first storage node is stored in the third storage node, then the third storage node may not pull any pages from the first storage node that are associated with the information from the storage request because the third storage node already has the most recent page for the information.

According to a specific embodiment, the computing device 105 may use the same identifier that was used to identify the second storage node, to identify the third storage node. The identifier may be a uniform resource name. The identifier may be stored in a page table 250, which may also include additional information that identifies the third storage node as the replacement for the second storage node. The page table 250 is described in further detail below.

According to the alternative embodiment depicted in FIG. 5, if at 345, computing device 105 determines that a second response is not received from the second storage node, and the second storage node is determined to have failed at 350, then computing device 105 may attempt to attempt to restore the second storage node. Specifically, computing device 150 may transmit a duplication quest to the first storage node to transmit information stored in the first storage node to the second storage node, step 500. Based on the duplication request, the first storage node may transmit the information to the second storage node, step 505.

According to alternative embodiment, at steps 500 and 505, computing device 105 may transmit a duplication request to the second storage node to copy (i.e., retrieve and store) information stored in the first storage node, alternative step 500. Based on the duplication request, the second storage node may communicate with the first storage node to copy the information, alternative step 505.

At 510, computing device 105 transmits a listen request to the second storage node that directs the second storage node to listen for storage requests that are issued by the computing device 105. The listen request may be included in the duplication request that is issued to the second computing device.

A storage request may be issued to both the first storage node and the second storage node to store information, step 515. The storage request may direct both the first and the second storage nodes to store the information associated with the storage request and direct the second storage node to overwrite any corresponding information that was copied from the first storage node, step 520.

At step, 525, the second storage node overwrites corresponding information that is copied from the first storage node. Alternatively, at steps 520 and 525, if the information associated with the storage request is stored in the second storage node before the information from the first storage node is stored in the second storage node, then the second storage node may not pull any pages from the first storage node that are associated with the information from the storage request because the second storage node already has the most recent page for the information.

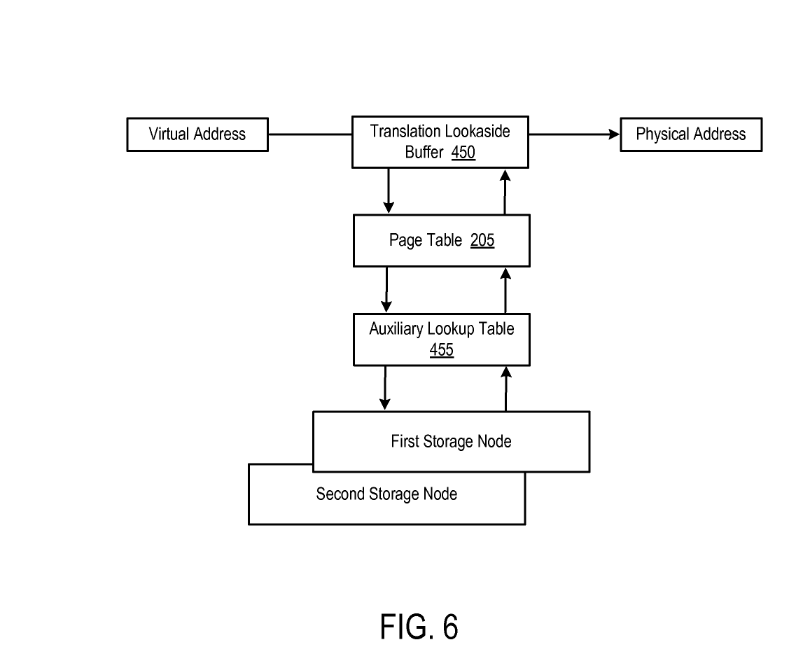

Referring to FIG. 6, this figure depicts an example interaction of the MMU 105d with the TLB 450 and the virtual mapping subsystem 105g according to one embodiment. The MMU 105d may access the TLB 450 and/or the virtual mapping subsystem 105g to determine whether data requested by the application 120 is in physical memory and to map a virtual address to a physical address. Access to the TLB 450 and/or the virtual mapping subsystem 105g is described below in detail.

As will be understood by those of skill in the art, the TLB 450 may cache mapping information that identifies the mappings of virtual addresses to physical addresses that have been relatively recently used. The TLB 450 may be cached in the processor 105a for fast access. According to one alternative embodiment, the TLB 450 may constitute a portion of the virtual memory subsystem 105g.

The virtual mapping subsystem 105g may provide a variety of mapping tables that allow MMU 105d to determine whether data requested at step 305 is in physical memory and to map virtual addresses to physical addresses. According to one specific embodiment, virtual mapping subsystem 105g provides the page table 205 and an auxiliary lookup table 455. Specifically, the MMU 105d may access the page table 205 to determine whether the data requested is in physical memory and to map a virtual address to a physical address, and may access the auxiliary table 455 if the data is not in physical memory.

The virtual mapping subsystem 105g may constitute a portion of the operating system 105b of the computing device 105 and specifically may constitute a portion of the operating system's kernel 105b′. The MMU 105d may also constitute a portion of the operating system's kernel 105b′. The operating system 105b of computing device 105 may be a Linux operating system that includes a Linux kernel. The MMU 105d may be included in the Linux kernel.

TLB 450 and page table 205 are presently described in further detail. As described briefly above, TLB 450 may cache mapping information that identifies the mappings of virtual addresses to physical addresses that have been relatively recently used. As will be understood by those of skill in the art, if mapping information exists in TLB 450 for the mapping between a given virtual address and the physical address, then the data is resident in physical memory. As will be further understood by those of skill in the art, page table 205 may include page table entries 206 that include mapping information for the mappings of virtual addresses to physical addresses for all data in physical memory and not just for virtual addresses and physical addresses that have been relatively recently used. More specifically, if the data requested at step 305 is in physical memory, then page table 205 may include mapping information that maps a virtual address to a physical address. Alternatively, if the data that is requested is not in physical memory, then page table 205 may not include mapping information for mapping the virtual address to the physical address.

Access to TLB 450, page table 205, and auxiliary lookup table 455 by MMU 105d is presently described. According to one embodiment, TLB 450, page table 205, and auxiliary lookup table 455 may be organized as a hierarchy. MMU 105d may traverse the hierarchy in an attempt to determine whether the data requested is in physical memory or has to be retrieved from storage nodes 115. MMU 105d may first accesses TLB 450 for the mapping information to determine if the data requested is in physical memory. If TLB 450 includes the mapping information, then MMU 105d will obtain the data using the TLB and will not need to access page table 205 and auxiliary lookup table 455. If TLB 450 does not include the mapping information, then MMU 105d may access page table 205 for the mapping information. If page table 205 includes the mapping information, then MMU 105d will obtain the data using the page table and will not need to access auxiliary lookup table 455. If page table 205 does not include the mapping information, then MMU 105d may use auxiliary lookup table 455 for loading pages from storage nodes 115 into physical memory to access the data requested.

According to one embodiment, and as described briefly above, auxiliary lookup table 455 may include a list of identifiers (e.g., entries) that identify the storage nodes 115 (e.g., the first and the second storage nodes) that store the data requested. The list of identifiers for the storage nodes may be indexed by the virtual addresses. MMU 105d may use the virtual address to access the auxiliary lookup table 140 to determine the particular storage nodes 115 that are associated with the virtual address. MMU 105d may then access the particular storage nodes 115 to retrieve the data requested from storage nodes 115. After the data is retrieved from the particular storage nodes 115 and is stored in physical memory, then MMU 105d may update the mapping information in page table 205 and TLB 450 to reflect the current mapping between the virtual address for the data and the physical address for where the data physically resides. Alternatively, kernel 105b′ may update the mapping information in page table 205 to reflect the current mapping between the virtual address and the physical address.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A method for retrieving stored information from a storage node, the method comprising operating a computing device to perform steps of:
generating a memory access request comprising a virtual memory address that identifies a first storage node and at least a second storage node based on the virtual memory address;
transmitting a retrieve request to both the first storage node and said at least second storage node to retrieve stored information from the first storage node or said at least second storage node, wherein the first storage node and said at least second storage node are each enabled to store a copy of the stored information, and wherein the first storage node and said at least second storage node are included in a plurality of storage nodes that constitute an extended memory; and
if a first response from the first storage node is received before a second response is received from said at least second storage node, then receiving the stored information from the first storage node.

2. The method of claim 1, further comprising, if the second response is received after the first response is received, then disregarding the second response.

3. The method of claim 1, wherein if said at least second storage node does not respond to the retrieval request, then determining whether said at least second storage node has failed, and replacing said at least second storage node with a replacement storage node from the plurality of storage nodes if said at least second storage node has failed.

4. The method of claim 3, wherein replacing said at least second storage node with the replacement storage node includes transmitting a listen request to the replacement storage node to listen for storage requests to store information that is associated with the listen request.

5. The method of claim 4, wherein replacing said at least second storage node with the replacement storage node further includes transmitting a duplication request to the first storage node to transmit information stored in the first storage node to the replacement storage node.

6. The method of claim 3, further comprising storing first information in a status table that identifies said at least second storage node as a failed node.

7. The method of claim 6, further comprising storing second information in the status table that identifies the replacement storage node as replacement node for said at least second storage node.

8. The method of claim 1, wherein each of the storage nodes comprises a server that includes random access memory, and the random access memories of the plurality of storage nodes constitute the extended memory that is addressable via the virtual memory address.

9. A non-transitory computer-readable storage medium comprising instructions for retrieving stored information from a storage node, wherein the instructions, when executed, are for controlling a computing device to be configured for:
generating a memory access request comprising a virtual memory address that identifies a first storage node and at least a second storage node based on the virtual memory address;
transmitting a retrieve request to both the first storage node and said at least second storage node to retrieve stored information from the first storage node or said at least second storage node, wherein the first storage node and said at least second storage node are each enabled to store a copy of the stored information, and wherein the first storage node and said at least second storage node are included in a plurality of storage nodes that constitute an extended memory; and
if a first response from the first storage node is received before a second response is received from said at least second storage node, then receiving the stored information from the first storage node.

10. The non-transitory computer-readable storage medium of claim 9, wherein if said at least second storage node does not respond to the retrieval request, then the instructions, when executed, are for further controlling the computing device to be configured for ascertaining whether said at least second storage node has failed, and for replacing said at least second storage node with a replacement storage node from the plurality of storage nodes if said at least second storage node has failed.

11. The non-transitory computer-readable storage medium of claim 10, wherein replacing said at least second storage node with the replacement storage node includes transmitting a listen request to the replacement storage node to listen for storage requests to store information that is associated with the storage request.

12. The non-transitory computer-readable storage medium of claim 11, wherein replacing said at least second storage node with the replacement storage node further includes transmitting a duplication request to the first storage node to transmit information stored in the first storage node to the replacement storage node.

13. The non-transitory computer-readable storage medium of claim 10, wherein the instructions, when executed, are for controlling a computing device to be configured for storing first information in a status table that identifies the second storage node as a failed node.

14. The non-transitory computer-readable storage medium of claim 13, wherein the instructions, when executed, are for controlling a computing device to be configured for storing second information in the status table that identifies the replacement storage node as replacement node for the second storage node.

15. A computing device for retrieving stored information from a storage node, the computing device comprising:
a processor; and
a computer-readable storage medium comprises instructions for controlling the processor to be configured for:
generating a memory access request comprising a virtual memory address that identifies a first storage node and at least a second storage node based on the virtual memory address;
transmitting a retrieve request to both the first storage node and said at least second storage node to retrieve stored information from the first storage node or said at least second storage node, wherein the first storage node and said at least second storage node are each enabled to store a copy of the stored information, and wherein the first storage node and said at least second storage node are included in a plurality of storage nodes that constitute an extended memory; and
if a first response from the first storage node is received before a second response is received from the at least second storage node, then receiving the stored information from the first storage node.

16. The computing device of claim 15, wherein if said at least second storage node does not respond to the retrieval request, then the computer-readable storage medium comprises instructions for further controlling the processor to be configured for ascertaining whether said at least said second storage node has failed and for replacing said at least second storage node with a replacement storage node from the plurality of storage nodes if said at least second storage node has failed.

17. The computing device of claim 16, wherein replacing said at least second storage node with the replacement storage node includes transmitting a listen request to the replacement storage node to listen for storage requests to store information that is associated with the storage request.

18. The computing device of claim 17, wherein replacing said at least second storage node with the replacement storage node further includes transmitting a duplication request to the first storage node to transmit information stored in the first storage node to the replacement storage node.

19. The computing device of claim 16, wherein the computer-readable storage medium comprises instructions for further controlling the processor to be configured for storing first information in a status table that identifies the second storage node as a failed node.

20. The computing device of claim 19, wherein the computer-readable storage medium comprises instructions for further controlling the processor to be configured for storing second information in the status table that identifies the replacement storage node as replacement node for the second storage node.
